(19) United States
(12) Patent Application Publication
(10) Pub. No.: US 2004/0193553 A1
(43) Pub. Date: Sep. 30, 2004

(54) Process for securing digital transactions

(76) Inventors: Joseph Alexander Lloyd, Warrenville, IL (US); Stephen Liberty, Winthrop, NY (US); Miguel Loyoza, Garden, KS (US)

Correspondence Address: JOSEPH LLOYD, 30 WEST 261 HOLYOHE COURT, WARRENVILLE, IL, 60555, US

(21) Appl. No.: 10/396,957

(22) Filed: Mar. 25, 2003

(51) Int. Cl. G06F 11/30

(52) U.S. Cl. 705/78

(57) ABSTRACT

Due to the inability of merchants to secure their data, the credit card/debit card/bank number information must be hidden in a way that the merchant receives only what is needed to process the order. For the system to be immune to hackers, it must be hardware and software based. The invention is a process in which consumer's information is put into a hardware device and encrypted into a package with two sections, the first which can be decrypted by merchants, the second which can be decrypted by credit card offices only. If the data is accurate, the transaction proceeds normally. This secures the credit card data 1) before a transaction occurs, 2) during a transaction, and 3) after a transaction occurs. This method of global protection is revolutionary and protects the credit card data in all possible ways, a solution that no other existing security solution even tries.

### FIELD OF INVENTION

The invention is directed to the protection of credit card/debit card/bank account numbers during online transactions.

Due to the impersonal nature of digital transactions, transactions involving a consumer paying with a credit card/debit card/bank account number, digital transactions can be abused. Due to the lack of need for a consumer to be physically present during a transaction credit card/debit card/bank account numbers can be obtained and used to make fraudulent transactions without the consumer's knowledge or consent. According to the meridian report, one(1) in ten(10) online orders is fraudulent. In 1997, credit card theft represented one point fourteen (1.14%) percent of all online transactions. In 2001 credit card theft represented over ten (10%) percent of online transactions. According to the Privacy Rights Clearinghouse, two billion dollars ($2,000,000,000) are lost annually due to online fraud. E-commerce as a market is damaged by the threat of fraud. Fraud impedes the growth of E-commerce. Security issues make consumers wary of purchasing online. E-commerce depends on the secure transfer of digital transactions. This secure transfer of information is not currently possible based on the current implementations of technology. Many types of security for digital transactions have been invented and are used today, such as SSL (Secure Sockets Layer) or “one-time use” disposable credit card numbers. These security measures deter fraud to a degree but do not solve issues of fraud, nor prevent them from occurring. No currently implemented security solution protects credit card/debit card/bank account number information from being stolen from merchants and from being stolen during transfer of information. The majority of instances of fraud originate from merchants who do not or cannot secure their databases from hackers.

### SUMMARY OF INVENTION

Due to the inability of merchants to protect their databases, the only way to secure the credit card/debit card/bank number information from an online merchant is to block that information from the merchant in a way that the merchant receives only what is needed to process and ship the order. If the online merchant is cut out from viewing the credit card/debit card/bank number information, the consumer can be assured the credit card/debit card/bank number information is not being stolen by the merchant.

To protect the merchant form stolen credit card/debit card/bank numbers or baseless orders, the credit card/debit card/bank offices need to verify that a consumer's ordering information is accurate.

For the system to be virtually immune to hackers, it must be hardware and software based.

The invention is a process in which the consumer fills out an ordering form in a software utility, on the consumer's computer, which is then sent to the hardware device attached to the consumer's computer and encrypted in a package. The package is encrypted in two sections. The primary section is based on encryption that all parties can decrypt using algorithms from the system's central cluster networks. The second section of the package contains the credit card/debit card/bank numbers and can only be decrypted by the consumer and the consumer's credit card/debit card/bank office. This package of data is sent to merchant. The merchant decrypts the primary portion of the package, which is the information needed to proceed with the transaction and ship the order. The package is then sent from the merchant to the credit card/debit card/bank office where it is fully decrypted and verified for validity. If the data the package contains is valid, the transaction proceeds normally.

### DETAILED DESCRIPTION OF INVENTION

The invention is the process in which digital media (credit card/debit card/bank account information) is secured, as described below. The statements below suggest specific implementations of the invention, but are not meant as limiting factors on the invention (a process) as claimed in the CLAIMS section.

This invention is to be distributed in the three different sections explained below, the Consumer Product, the Merchant Product and the Credit Card/Debit Card/Bank office Product. The consumer hardware device is to be manufactured using components available and specified and/or recommended above.

The consumer product consists of two components: A hardware Device: a physical hardware device which serves as consumer information package generator, and a Software Application: a software program to securely input data into the hardware device. Also included is a browser patch to convert e-commerce ordering forms into ordering forms that work with the software application.

The hardware Device—Purpose: to generate secure consumer information packages for secure e-commerce transactions. The hardware device is based on two major hardware components: a processing device (recommended: low-power RISC processing unit) and a memory device (recommended: Flash-ROM memory module). To update the hardware device, a jumper switch, protruding from the exterior of the device can be used. When in the ‘on’ position, the memory module can be updated using software flashing devices on the consumer computer. This feature is available for security purposes, in effort to prevent fraudulent updates of memory device via internet or network connections. By specification, the hardware Device connects to, and is powered by conventional phoneline (RJ-11) or RJ-45 CAT5e network cable (in cable modem or DSL usage). This specification is based on power consumption of the device, and if need be will be expanded to an external power device.

The Software Application—Purpose: to communicate with, and channel information to the Hardware Device. The software will take all information necessary for an e-commerce transaction inputted by a consumer and channel it to the Hardware Device. The software checks for compatible merchants. When a consumer attempts to order from a compatible merchant over the internet, The software opens up a menu for the consumer to safely and securely input name, address, shipping address, phone, credit card/debit card/banking number and company. This form of information is then sent to the Hardware Device. The Hardware Device bundles and encrypts the information package together as a consumer information package and sends the consumer information package to the appropriate merchant for decryption and processing of the data to complete the transaction. Another function within the software is to check the central cluster networks for updates to the software and for the Hardware Device. This task is similar to current implementations of update searches.

Merchant Product—Purpose: To (1) make merchant web site compatible, (2) capable of receiving consumer information packages, and (3) decrypt and process consumer information package information. The merchant product is primarily a software application to convert the merchant e-commerce web site into a site compatible with this system. This software is to be written to allow merchants to accommodate and decrypt consumer information packages during an online transaction. The software will be able to receive the consumer information package from the consumer hardware device over a standard internet connection. The software application will be in communication with the central cluster network in order to receive the decryption algorithm sets (as explained in

By using the information gained from communication with the central cluster networks, the merchant application software will decrypt the primary portion of the consumer information package. This information will be sufficient for the merchant to be able to proceed with the online transaction process. The software application then relays the entire encrypted consumer information package to credit card/debit card/bank office. As the final task of the merchant software application, it receives the consumer information package again from the credit card/debit card/bank office and processes the order properly.

Credit card/debit card/bank office product—Purpose: to (1) make credit card/debit card/bank office compatible with the system, (2) capable of receiving consumer information packages, (3) capable of decrypting and processing consumer information package information, and (4) re-transmitting the consumer information package. The credit card/debit card/bank office will need to approve a digital transaction. To do so, the credit card/debit card/bank office's software application will be able to receive and decrypt the primary portion of a consumer information package. After primary decryption, the consumer's name, address, and identifier information is matched with the credit card/debit card/bank office's internal database. From the internal database, a pre-established key-based encryption algorithm (recommended: PGP-like encryption), specific to a certain customer will be used to decrypt the secondary portion of the consumer information package. If decryption fails, the transaction is considered fraudulent, either encrypted with a false identifier, or inputted with false identification of the consumer. The software application will be in communication with the central cluster network in order to receive the decryption algorithm sets for the primary encrypter (as explained in [0014]).

The internal network will be a series of high-availability networks (recommended: clusters). These networks will initiate output-only signals to be relayed to the consumer hardware device, and the software for merchants and the credit card/debit card/bank offices.. There will be one or more synchronized networks for transmitting the codes for encrypting/decrypting the consumer information packages.

The consumer information package is the package of data containing sensitive information of the consumer. This information includes Credit Card/Debit Card numbers, bank accounts and possibly check identifications. This system can later be expanded to include the transfer of any information, including tax reports, insurance information, and documents of any sensitive nature. The purpose of the consumer information package is to safely and securely transfer sensitive data during an online transaction. The consumer information package contains two levels of information: (1)Primary Layer—non-sensitive data including consumer name, address, phone numbers, shipping address, merchant-dependant information, and credit card identifier, and (2) Secondary Layer—Sensitive information, such as credit card number, debit card number bank accounts and possibly check identifications. The primary level of information is encrypted with standard encryption (symmetric cryptography), like the ‘idea’ and ‘CAST’ formats used in the current implementation of SSL. This changes at a certain time interval, regulated by the central cluster networks. The number generated by the cluster network is relayed to the consumer hardware, merchant software and credit card/debit card/bank office software. This number refers to a pre-encoded list of algorithms to encrypt the primary level of encryption. Underneath this primary layer of information and security, is the secondary layer of information. This is encrypted with an implementation of a key-based encryption algorithm (recommended: PGP-like encryption). The consumer will pre-establish a key with the credit card/debit card/bank offices. Using the Consumer's private key and the credit card/debit card/bank office's public key, the secondary layer of information is encrypted. To decrypt this layer, the decryption engine must use the consumer's public key and the credit card/debit card/bank office's private key. Each key used will be generated by the credit card/debit card/bank office prior to use, and will contain a different algorithm for decryption that is personalized and unique to every user. To regulate this, the credit card/debit card/bank office must register algorithm space with the central cluster networks to eliminate duplicate key codes. Together, with the secondary layer of information encrypted under the primary layer of information that is also encrypted, the consumer information package is then sent over the World Wide Web for completion of the c-commerce transaction process. To prevent duplication of the consumer information package and prolonged storage on insecure servers and databases, the consumer information package has a limited lifetime. The consumer information package will only be executable within a certain time of its creation. After this time limit has passed, the consumer information package will self-destruct by deleting itself from any computer system. This is accomplished by an internal counter clock, running off the system clock of the host processor and not dependant on the internal clock of the computer itself. By counting down based on the speed of the processor, the time limit can not be exceeded.

This invention is to be used as a process for preventing fraudulent digital transactions. The three components of the system, Consumer Product, the Merchant Product and the Credit Card/Debit Card/Bank office Product will be distributed to their respective locations and together form the process of the invention.

The description of the invention above is targeted to specific areas of the invention and the description is meant in no means as a limitation, and is intended to also cover modifications that fall under the claims stated below.

We claim:

1) A Process for securing online transactions based on software and hardware components, multiple sections of multiple encryption types in a self-destructing package of data sent to merchants, who can only decrypt information needed to process the order and relay the transaction, sent to credit card/debit card/bank offices for verification of data and finalization of a digital transaction.

2) The method of claim 1 wherein information from the consumer is entered by via computer into a software program that relays data to the hardware device attached to the computer, which encrypts the data and transmits it to the merchant who partially decrypts the data package and then relays it to the credit card/debit card/bank office for full decryption using software programs.

3) The method of claim 1 wherein consumer information is packaged securely using a hardware device.

4) The method of claim 1 wherein the whole package of consumer data is encrypted by an encryption algorithm (primary encryption) that is valid within a certain window of time.

5) The method of claim 1 wherein consumer credit card/debit card/bank number is encrypted by a key-based algorithm that is only available to the specific consumer and the credit card/debit card/bank offices used by that consumer.

6) The method of claim 1 wherein consumer information is protected in a self-erasing package that deletes itself after a specified amount of time.

7) The method of claim 1 wherein the process is regulated by secure central cluster networks

8) The method of claim 1 wherein the merchant can only decrypt and process information critical to the transaction (name, address shipping method, shipping address, phone numbers, fax numbers, cell numbers, email accounts, and credit card/debit card/bank type).

9) The method of claim 1 wherein the credit card/debit card/bank office can decrypt the primary portion of the consumer's data, use that to match names with a customer, use the customer's private key-based encryption algorithm to decrypt the credit card/debit card/bank number, verify the validity of that information, approve the order, and charge the credit card/debit card/bank number appropriately.

10) The method of claim 3 wherein the hardware device has an integrated processing device and readable memory device to operate and encrypted packages of data outside of the main computer's resources.

11) The method of claim 3 wherein the hardware device's readable memory device can only be written to when a hardware switch is enabled.

12) The method of claim 7 wherein regulation is provided by the central cluster networks sending code to merchants and credit card/debit card/bank offices to base the primary encryption (specified in claim 4) on within the specified time amount.

13) The method of claim 7 wherein the central networks are synchronized.

14) The method of claim 8 wherein the merchant does not have access to the key-based encryption algorithm for decryption of the credit card/debit card/bank number and cannot decrypt this information.
